(19) United States
(12) Patent Application Publication
(10) Pub. No.: US 2008/0259149 A1
(43) Pub. Date: Oct. 23, 2008

(54) MONOLITHIC FLUID INJECTION DEVICE AND METHOD FOR FABRICATING AND OPERATING THEREOF

(75) Inventors: Chung-Cheng Chou, Taoyuan County (TW); Wai Wang, Taoyuan County (TW)

Correspondence Address: QUINTERO LAW OFFICE, PC, 2210 MAIN STREET, SUITE 200, SANTA MONICA, CA, 90405, US

(73) Assignee: QISDA CORPORATION, TAOYUAN COUNTY (TW)

(21) Appl. No.: 11/960,531

(22) Filed: Dec. 19, 2007

(30) Foreign Application Priority Data
Apr. 19, 2007 (TW) TW96113787

(51) Int. Cl. B41J 3/36

(52) U.S. Cl. 347/109; 29/890.1

(57) ABSTRACT

The invention provides a monolithic fluid injection device and method for fabricating and operating thereof. The device comprises a substrate and a structural layer disposed thereon to form a fluid chamber therebetween for storing a fluid therein. The device further comprises a liquid level control unit formed on the structural layer and a nozzle passed through the liquid level control unit and structural layer to communicate with the fluid chamber. The liquid level control unit adjusts liquid level of fluid in the nozzle to eject a droplet with various volume and direction.

### BACKGROUND OF THE INVENTION

1. Field of the Invention

The invention relates to monolithic fluid injection devices, and more particularly to a monolithic fluid injection device with a liquid level control unit and method for fabricating and operating thereof.

2. Description of the Related Art

As the development of inkjet printer printing techniques increase, demand for higher quality and higher resolution of inkjet printers also increase. Generally, quality and resolution of printed images are related to ejected droplet's performances such as flying speed, volume, direction, etc.

FIG. 1 is a cross section of a conventional monolithic fluid injection device 1. Referring to FIG. 1, a structural layer 12 is formed on a silicon substrate 10, and a first heater 16 and second heater 18 are disposed on the structural layer 12. A fluid chamber 14 is formed between the structural layer 12 and the silicon substrate 10 and a fluid is provided therein via a fluid channel 20. The first heater 16 generates a first bubble 22 and the second heater 18 generates a second bubble 24 to eject a droplet. Because droplet volume is not precisely controlled, the conventional monolithic fluid injection device has relatively inferior quality and resolution. Moreover, because the conventional monolithic fluid injection device can not precisely control the direction of droplet ejection, in effects to raise resolution, the amount of nozzles must increase, resulting in increased fabrication costs.

Thus, a monolithic fluid injection device capable of more precisely controlling ejected volume and direction of droplets and a method for fabricating thereof is needed to improve quality and resolution of a monolithic fluid injection device.

### BRIEF SUMMARY OF INVENTION

The invention provides a monolithic fluid injection device. An exemplary embodiment of the monolithic fluid injection device comprises a substrate, a structural layer disposed on the substrate to form a fluid chamber therebetween for storing a fluid, a liquid level control unit formed on the structural layer, and a nozzle through the liquid level control unit and structural layer to communicate with the fluid chamber.

Also provided is a method for fabricating a monolithic fluid injection device. The method comprises providing a substrate, forming a structural layer on the substrate and a fluid chamber therebetween to store a fluid, forming a liquid level control unit on the structural layer, and forming a nozzle passed through the liquid level control unit and structural layer to communicate with the fluid chamber.

The invention further provides the operational method of a monolithic fluid injection device comprising a first liquid level control unit, which comprises a first electrode contacted with fluid inside the monolithic fluid device, a second electrode wrapped by a dielectric, and a first nozzle passed through the liquid level control unit. The operation method comprises providing a voltage with a first polarity to the fluid by the first electrode, providing a voltage with a second polarity opposite the first polarity to the dielectric layer by the second electrode to control liquid level of the fluid in the first nozzle, providing a bubble to the fluid so as to eject a droplet from the first nozzle.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a cross section of a conventional monolithic fluid injection device;

FIGS. 2A-2F are cross sections of a method for fabricating a monolithic fluid injection device according to an embodiment of the invention; and

FIGS. 3A-3C are schematic view of a method for operating a monolithic fluid injection device according to an embodiment of the invention.

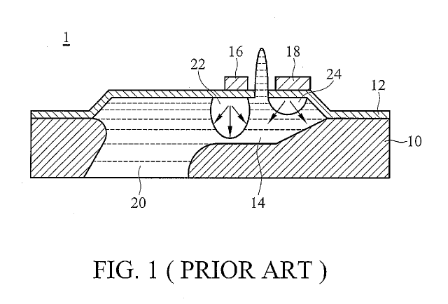

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

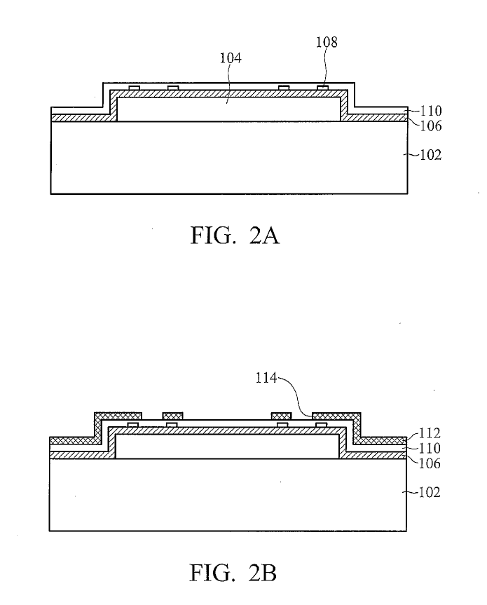

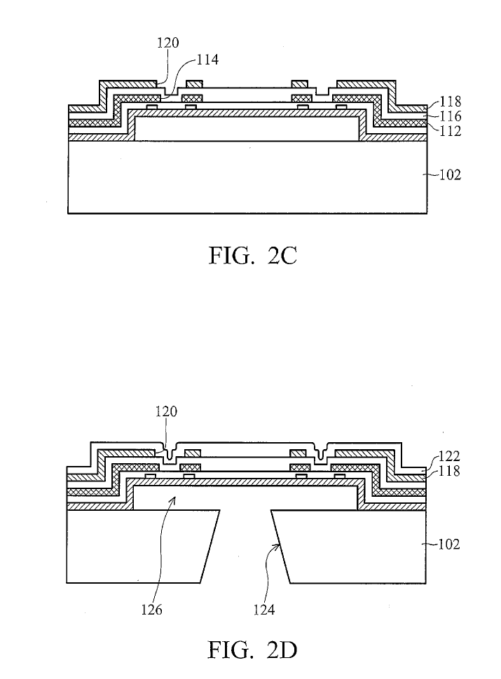

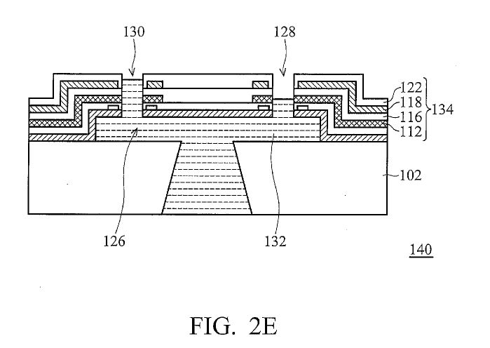

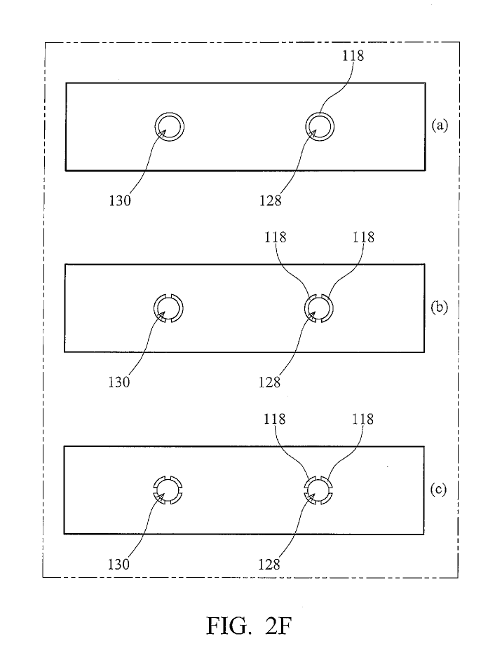

FIGS. 2A-2E are cross sections of a method for fabricating a monolithic fluid injection device according to an embodiment of the invention. FIG. 2F is a plan view of a nozzle of a monolithic fluid injection device according to an embodiment of the invention.

In FIG. 2A, a substrate 102 such as monocrystalline silicon substrate is provided and a sacrificial layer 104 is formed thereon. In some embodiments, a layer such as boron phosphate silicate glass (BPSG), phosphate silicate glass (PSG), or other suitable oxide layer is deposited on the substrate 102 by chemical vapor deposition (CVD). The layer is then patterned by photolithography and etching to form the sacrificial layer 104, by which to determine the dimensions of a fluid chamber subsequently formed.

Next, a structural layer 106 is conformally formed on the substrate 102 and covers the sacrificial layer 104. In one embodiment, the structural layer 106 such as low stress nitride is formed on the substrate 102 and covers the sacrificial layer 104 by CVD. Preferably, the low stress nitride layer has a stress level of between 100 to 200 MPa.

Thereafter, an actuator 108 is then formed on the structural layer 106 to generate a bubble. In one embodiment, the actuator 108 may be a heater made of resistor layer, for example hafnium boride (HfB₂), tantalum aluminum (TaAl), or titanium nitride (TiN) formed by evaporating, sputtering or chemical sputtering. A protective layer 110 such as silicon oxide is subsequently formed on the structural layer 106 and covers the actuator 108.

In FIG. 2B, a first conductive layer 112 having a first opening 114 is formed on the structural layer 106. Preferably, the first conductive layer 112 is aluminum (Al), copper (Cu), gold (Au), or any suitable conductive material. In some embodiments, the first conductive layer 112 is formed on the substrate 102 by evaporating, sputtering, or electroplating. A portion of the first conductive layer 112 is subsequently removed by photolithography and etching to form the first opening 114 in the first conductive layer 112 and expose the protective layer 110. Note that the first opening 114 is the disposition where a nozzle subsequently formed.

Referring to FIG. 2C, a first dielectric layer 116 is conformally formed on the first conductive layer 112 followed by the forming of a second conductive layer 118 having a second opening 120 thereon. Preferably, the first dielectric layer 116 may be silicon oxide, silicon nitride, silicon oxynitride, or other suitable dielectric material.

In one embodiment, the first dielectric layer 116 is formed on the first conductive layer 112 and extended to the first opening 114 by CVD or any suitable manner. The second conductive layer 118 is subsequently formed on the first dielectric layer 116 by, for example sputtering, evaporating, or electroplating. A portion of the second conductive layer 118 is then removed by photolithography and etching to form the second opening 120 in the second conductive layer 118. In some embodiments, the material of the second conductive layer 118 is the same as the first conductive layer 112.

Note that the second opening 120 is larger than the first opening 114. Specifically, the distance between the second opening 120 sidewalls of the second conductive layer 118 is greater than the first opening 114 sidewall of the first conductive layer 112.

Referring to FIG. 2D, a second dielectric layer 122 is conformally formed on the conductive layer 118 and extends to the second opening 120. Preferably, the formation method and material utilized for the second dielectric layer 122 is similar to that of the first dielectric layer 116. The substrate 102 is etched from its back side by using an etchant comprising potassium hydroxide (KOH) to form a fluid channel 124. The sacrificial layer 104 (as shown in FIG. 2A) is subsequently removed by an etchant such as hydrogen fluoride acid (HF) to form a fluid chamber 126 between the substrate 102 and the structural layer 106 (as shown in FIG. 2A).

As shown in FIG. 2E, a first nozzle 128 and second nozzle 130 are then formed to communicate with the fluid chamber 126. In one embodiment, a portion of the second dielectric layer 122, second conductive layer 118, first dielectric layer 116, first conductive layer 112 and structural layer 106 is removed by, for example, plasma etching, reactive ion etching (RIE), or any suitable dry-etching to form the first and second nozzles 128, and 130. The second dielectric layer 122, second conductive layer 118, first dielectric layer 116 and first conductive layer 112, which are above the substrate 102, constitute a liquid level control unit 134. Specifically, the first and second nozzles 128, and 130 communicate with the fluid chamber 126 by passing through the liquid level control unit 134 and structural layer 106. A fluid 132, which is an electrolyte such as ink, is subsequently provided in the fluid chamber 126 via the fluid channel 124 (as shown in FIG. 2D). Completing an embodiment of fabricating of a monolithic fluid injection device.

Note that the first conductive layer 112 serves as a first electrode of the liquid level control unit 134 and is in contact with the fluid 132 to provide a voltage to fluid 132. The first dielectric layer 116 serves as an isolation layer between the first conductive layer 112 and second conductive layer 118. The second conductive layer 118 acts as a second electrode of the liquid level control unit 134 and the second dielectric layer 122 covers the second conductive layer 118 and its sidewalls to separate the second conductive layer 118 from the fluid 132. Thus, the second conductive layer 118 is not in contact with the fluid 132.

In some embodiments, while the first conductive layer 112, also referred to as a first electrode, provides a voltage having a polarity such as negative to the fluid 132, ion of fluid 132 having a second polarity opposite the first polarity, for example positive accumulates around the first conductive layer 112. Ion of fluid 132 having a polarity the same as the first polarity, however, is away from the first conductive layer 112. Moreover, the second conductive layer 118 provides a voltage having the second polarity such as positive to the second dielectric layer 122, so that a surface of the second dielectric layer 122 is full of ion with second polarity. Ion of the fluid 132 with first polarity is attracted to the surface of second dielectric layer 122. Thus, surface tension between second dielectric layer 122 and the fluid 132 is reduced. That is, the second dielectric layer 122 with hydrophobic is transmitted into hydrophilic by providing a voltage to the fluid 132 and the second dielectric layer 122 to adjust liquid level of the fluid 132 in first and second nozzles 128, and 130 for ejecting droplets with various volume. Preferably, the fluid 132 is capable of conductivity, for example electrolyte.

It is appreciated that the liquid level control unit 134 may also serve as a nozzle layer and each liquid level control unit 134 may respectively connect to a control unit (for example control circuit) to independently adjust the liquid level of fluid in each nozzle. As shown in FIG. 2E, the liquid level control unit 134 disposed on the first nozzle 128 is in off state (power off), and that disposed on the second nozzle 130 is in on state (power on), so that a height of liquid level of fluid 132 in second nozzle 130 is higher than that in first nozzle 128.

Note that the liquid level control unit on the nozzle may also be divided into several parts to accurately or variously adjust the liquid level of the fluid in the nozzle so as to eject a droplet with various volume and direction. Moreover, formation of the liquid level control unit is associated with fabrication of a monolithic fluid injection device, thus, additional cost is not necessary.

FIG. 2F shows a plan view of a nozzle of a monolithic fluid injection device having a liquid level control unit. In (a) of FIG. 2F, a second conductive layer 118, by which a liquid level control unit is constituted, is formed in the first and second nozzles 128 and 130 to adjust liquid level of fluid in first and second nozzles 128 and 130, respectively. In one embodiment, the second conductive layer 118 in each of nozzles is divided into two parts, as shown in (b) of FIG. 2F. That is, two of liquid level control units (depicted by second conductive layer 118) are respectively formed on the first and second nozzles 128 and 130 to adjust liquid level of fluid in each nozzle into a non-plane and further eject a droplet with a direction in an angle.

As shown in (c) of FIG. 2F, the second conducive layer 118 may be divided into four parts without changing formation of the first dielectric layer, second conductive layer and second dielectric layer to provide four quantity of liquid level control units (each liquid level control unit is operated respectively) in each first and second nozzle 128 and 130. The liquid level of fluid in each nozzle is accurately and variously controlled by the liquid level control unit, which has four quantities, so that the liquid level in each nozzle is non-plane to eject a droplet in a direction from each nozzle.

Note that a plurality of liquid level control units are stacked on the liquid level control unit and respectively connect control units to independently adjust liquid level of fluid in nozzle for accurate controlling the volume and direction of ejected droplet.

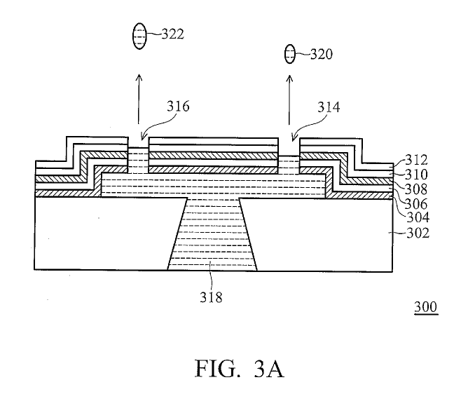

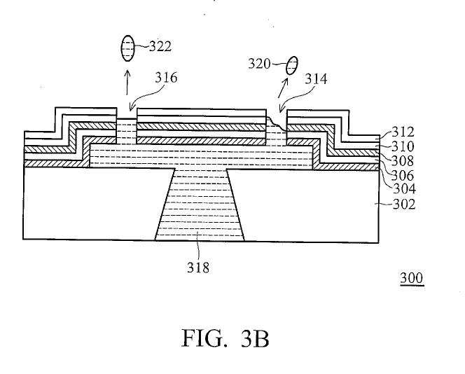

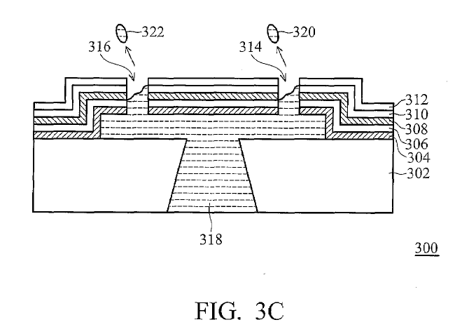

FIGS. 3A-3C are schematic views of a method for operating a monolithic fluid injection device. In them, some elements may be omitted to clearly illustrate.

FIG. 3A is a schematic view of a method for operating a monolithic fluid injection device 300 according to an embodiment of the invention. In FIG. 3A, a substrate 302, on which a structural layer 304 is formed thereon, is provided. Then, first, second, third, and fourth liquid level control units 306, 308, 310, and 312 are sequentially formed on the structural layer 304. First, second nozzles 314, and 316 are subsequently formed in the liquid level control units 306, 308, 310, and 312 and pass through the liquid level control units 306, 308, 310, and 312 and the structural layer 304 to communicate with a fluid chamber. A fluid 318 is subsequently provided to fluid chamber. Fabrication of a monolithic fluid injection device, as shown in FIG. 3A, is complete.

In FIG. 3A, each of liquid level control units is merely depicted by a single layer. It is appreciated that the single layer at least comprises a first electrode, which provides a voltage to a fluid, a second electrode and a dielectric layer, which covers the second electrode. While the first and second electrodes provide a voltage to the fluid and the dielectric layer, respectively, a surface of the dielectric layer is transmitted from hydrophobic into hydrophilic to adjust liquid level of fluid in a nozzle. Note that each liquid level control unit, which is correspondingly formed on the nozzle, is independently controlled to adjust the liquid level of fluid in the nozzle. Moreover, an actuator (not depicted) is formed between the structural layer and the first liquid level control unit and close to sidewalls of the nozzle to generate a bubble for ejecting a droplet.

In one embodiment, first and second liquid level control units 306, and 308 formed on the first nozzle 314 are in on state, and first, second and third liquid level control units 306, 308, and 310 formed on the second nozzle 316 are in on state, to adjust liquid level of fluid 318 in the second nozzle 316 higher than that in the first nozzle 314 and further eject first and second droplets 320 and 322 with different volume to each other.

Note that the first electrode of each liquid level control unit, which contacts the fluid, may provide a similar voltage in order to sustain a common polarity of fluid in the nozzle. In another embodiment, however, the first electrode of any one of liquid level control units, which contacts the fluid, may provide a voltage with a polarity to sustain the polarity of fluid in the nozzle. That is, a monolithic fluid injection device, in which a single first electrode is associated with a plurality of second electrodes wrapped around by dielectric layer, may be fabricated and operated. This case may be utilized in following embodiments, thus, it is not provided in subsequent description

The each liquid level control unit may be divided into several parts, correspondingly disposed on the nozzle in parallel, and independently operated, as shown in FIG. 2F. In FIG. 3B, a first liquid level control unit 306, which is at right side of the first nozzle 314, is in power on state, and first, second, and third liquid level control units 306, 308, and 310, which are at left side of the first nozzle 314, are in power on state to adjust the liquid level of fluid 318 in left side of first nozzle 314 is higher than that in right side. That is, the fluid 318 in the first nozzle 314 has a top liquid level and lower liquid level and the top liquid level is unequal to lower liquid level, so that the liquid level of the fluid 318 is non-plane.

As shown in FIG. 3B, first, second and third liquid level control units 306, 308, and 310, which are in both sides of the second nozzle 316, are in power on state to adjust the liquid level of the fluid 318 in second nozzle 316 is plane. A bubble is generated by actuator to eject first and second droplets 320 and 322 from first and second nozzles 314 and 316, respectively. Note that, the first droplet 320 is ejected from the first nozzle 314 in a direction because the liquid level of fluid 318 therein is non-plane.

FIG. 3C is a schematic view of a method for operating a monolithic fluid injection device 300 having a liquid level control unit. In FIG. 3C, the first liquid level control unit 306, which is at left side of the first nozzle 314, is in power on state. At right side of the first nozzle 314, the first, second and third liquid level control units 306, 308 and 310 are in power on state, so that the liquid level of fluid 318 in the first nozzle 314 is non-plane. In the second nozzle 316, the first liquid level unit 306 at right side is in power on state, and at the right, the first, second and third liquid level control units 306, 308 and 310 are in on state, thus, the liquid level of fluid 318 in second nozzle 316 is non-plane. The bubble is generated by the actuator to eject the first and second droplets 320 and 322 with a direction from the first and second nozzles 314 and 316 in an angle, respectively. (as arrows shown in FIG. 3C)

Note that the liquid level of fluid in each nozzle is controlled by the liquid level control unit and operation thereof, to eject a droplet with various volume and direction. Thus, printing quality of monolithic fluid injection device such as printhead is improved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A monolithic fluid injection device, comprising:
a substrate;
a structural layer disposed on the substrate and a fluid chamber formed therebetween to store a fluid;
a liquid level control unit formed on the structural layer; and
a nozzle passed through the liquid level control unit and the structural layer to communicate with the fluid chamber.

2. The device as claimed in claim 1, wherein the liquid level control unit comprises:
a first conductive layer formed on the structural layer and in contact with the fluid;
a first dielectric layer formed on the first conductive layer;
a second conductive layer formed on the first dielectric layer; and
a second dielectric layer formed on the second conductive layer and wrapped up the second conductive layer.

3. The device as claimed in claim 2, wherein the liquid level unit is divided into two parts surrounding the nozzle and connected to a control circuit respectively.

4. The device as claimed in claim 2, wherein the liquid level unit is divided into four parts surrounding the nozzle and connected to a control circuit respectively.

5. The device as claimed in claim 1, further comprising:
at least one actuator formed on the structural layer; and
a protective layer formed between the structural layer and the liquid level unit and covering the actuator.

6. The device as claimed in claim 1, wherein the structural layer comprises a lower stress nitride.

7. The device as claimed in claim 2, wherein the first and second conductive layers comprise copper, gold or aluminum.

8. A method for fabricating a monolithic fluid injection device, comprising:
providing a substrate;
forming a structural layer on the substrate and a fluid chamber therebetween to store a fluid;
forming a liquid level control unit on the structural layer; and
forming a nozzle in the liquid level control unit and the structural layer to communicate with the fluid chamber.

9. The method as claimed in claim 8, wherein forming the fluid chamber comprises:
forming a sacrificial layer between the substrate and the structural layer; and
removing the sacrificial layer to form the fluid chamber.

10. The method as claimed in claim 8, wherein forming the liquid level control unit comprises:
forming a first conductive layer on the structural layer;
forming a first dielectric layer on the first conductive layer;
forming a second conductive layer on the first dielectric layer; and
forming a second dielectric layer on the second conductive layer and extending to a sidewall of the second conductive layer to contact the first dielectric layer.

11. The method as claimed in claim 10, after forming the second conductive layer further comprising forming an opening in the second conductive layer so as to extend the second dielectric layer to sidewalls of the second conductive layer.

12. The method as claimed in claim 10, wherein forming the nozzle comprises removing a portion of the second dielectric layer, first dielectric layer and structural layer to form the nozzle therein and expose a portion of the first conductive layer to the fluid.

13. The method as claimed in claim 12, wherein the portion of the second dielectric layer, first dielectric layer and structural layer are removed by reactive ion etching or plasmas etching.

14. A method for operating a monolithic fluid injection device comprising a first liquid level control unit having a first electrode contacted to a fluid in the device and a second electrode wrapped around by a first dielectric layer, and a first nozzle passed through the liquid level control unit, the method comprising:
providing a voltage having a first polarity to the fluid by the first electrode;
providing a voltage having a second polarity opposite the first polarity to the first dielectric layer to control a liquid level of the fluid in the first nozzle; and
providing a bubble to the fluid so as to eject a first droplet from the first nozzle.

15. The method as claimed in claim 14, wherein the liquid level of the fluid in the first nozzle is non-plane so as to eject the first droplet from the first nozzle in a direction.

16. The method as claimed in claim 14, further comprising:
providing a voltage to a second liquid level control unit to control a liquid level of the fluid in a second nozzle; and
providing a bubble to the fluid to eject a second droplet from the second nozzle.

17. The method as claimed in claim 16, wherein the liquid level of the fluid in the second nozzle is non-plane so as to eject the second droplet from the second nozzle in a direction.

18. The method as claimed in claim 16, wherein the fluid in the second nozzle has a top height of the liquid level unequal to that in the first nozzle.

19. The method as claimed in claim 16, wherein the second droplet has a volume unequal to the first droplet.

20. The method as claimed in claim 17, wherein the direction of the second droplet is unequal to the first droplet.
